(19) United States
(12) Patent Application Publication
(10) Pub. No.: US 2025/0391588 A1
(43) Pub. Date: Dec. 25, 2025

(54) WIRES FOR DEVICES USED IN HIGH-TEMPERATURE ENVIRONMENTS

(71) Applicant: Woodward Inc., Fort Collins, CO (US)

(72) Inventor: Michael Day, Roscoe, IL (US)

(21) Appl. No.: 19/245,501

(22) Filed: Jun. 23, 2025

Related U.S. Application Data
(60) Provisional application No. 63/663,948, filed on Jun. 25, 2024.

(51) Int. Cl. H01B 7/29; H01B 1/02

(52) U.S. Cl. CPC H01B 7/292; H01B 1/023; H01B 1/026

(57) ABSTRACT

Wires are disclosed. A wire includes a metallic core conductor material and a metallic clad conductor material. The core conductor material has a first resistance and the clad conductor material has a second resistance greater than the first resistance. The clad conductor material is configured to form an oxidation barrier to at least partially shield the core conductor material from oxidation in an oxygen-containing, high-temperature environment.

### CROSS-REFERENCE TO RELATED APPLICATIONS

The present disclosure claims priority to, and the benefit of, U.S. Provisional Patent Application No. 63/663,948, which was filed on Jun. 25, 2024. The contents of that disclosure are incorporated herein by reference in their entirety.

### TECHNICAL FIELD

The present disclosure generally relates to wires for electro-magnetic devices, and, more particularly, to wires for electro-magnetic devices used in high-temperature environments.

### BACKGROUND

In a variety of applications, high-temperature engine environments pose survivability challenges for wires and/or windings subjected to those environments. Design and manufacturing of such wires may account for factors such as mechanical stress and thermal degradation, among others. Devices, systems, and/or methods that address operability concerns for wires used in high-temperature environments remain an area of interest.

### SUMMARY

The present disclosure may comprise one or more of the following features and combinations thereof.

According to one aspect of the present disclosure, a wire may include a metallic conductor material, a metallic clad conductor material, and a metallic interlayer. The core conductor material may have a first resistance. The clad conductor material may have a second resistance greater than the first resistance. The interlayer may be arranged between the core conductor material and the clad conductor material to at least partially inhibit deleterious intermetallic formation between the clad conductor material and the core conductor material.

In some embodiments, the clad conductor material may include aluminum, the core conductor material may include copper, and the interlayer may include copper and aluminum.

In some embodiments, the wire may include an anodized skin formed on the aluminum clad conductor material.

In some embodiments, the clad conductor material may include 1000 series aluminum.

In some embodiments, the clad conductor material may include 2000 series aluminum.

In some embodiments, the clad conductor material may include 6000 series aluminum.

In some embodiments, the aluminum material may account for at least 90% of the interlayer.

In some embodiments, the copper material may account for at least 5% of the interlayer.

In some embodiments, the clad conductor material may include aluminum, the core conductor material may include copper, and the interlayer may include copper, nickel, and aluminum.

In some embodiments, the copper material may at least partially form a radially innermost layer of the interlayer, the aluminum material may at least partially form a radially outermost layer of the interlayer, and the nickel material may at least partially form an intermediate layer between the radially innermost layer and the radially outermost layer.

According to another aspect of the present disclosure, a wire may include a metallic conductor material, a metallic clad conductor material, and an anodized skin formed on the clad conductor material. The core conductor material may have a first resistance. The clad conductor material may have a second resistance greater than the first resistance.

In some embodiments, the core conductor material may include copper and the clad conductor material may include aluminum.

In some embodiments, the core conductor material may include silver and the clad conductor material may include aluminum.

In some embodiments, the core conductor material may include gold and the clad conductor material may include aluminum.

In some embodiments, the core conductor material may include copper and the clad conductor material may include copper and aluminum.

In some embodiments, the anodized skin may be formed on the aluminum clad conductor material, the copper material may at least partially form a radially innermost layer of the clad conductor material, and the aluminum material may at least partially form a radially outermost layer of the clad conductor material.

In some embodiments, the clad conductor material may include nickel, the copper material may at least partially form a radially innermost layer of the clad conductor material, the aluminum material may at least partially form a radially outermost layer of the clad conductor material, and the nickel material may at least partially form an intermediate layer between the radially innermost layer and the radially outermost layer.

According to yet another aspect of the present disclosure, a wire may include a metallic core conductor material and a metallic clad conductor material. The core conductor material may have a first resistance. The clad conductor material may have a second resistance greater than the first resistance. The core conductor material may include copper. The clad conductor material may include copper and aluminum. The copper material may at least partially form a first layer of the clad conductor material. The aluminum material may at least partially form a second layer of the clad conductor material arranged radially outward of the first layer.

In some embodiments, the clad conductor material may include nickel and the nickel material may at least partially form a third layer of the clad conductor material between the first layer and the second layer.

In some embodiments, the first layer and the third layer of the clad conductor material may at least partially inhibit deleterious intermetallic formation between the core conductor material and the second layer of the clad conductor material.

These and other features of the present disclosure will become more apparent from the following description of the illustrative embodiments.

### BRIEF DESCRIPTION OF THE FIGURES

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 is a cut-away perspective view of a gas turbine engine;

FIG. 2 is a cross-sectional view of a wire or winding in accordance with one embodiment of the present disclosure;

FIG. 3 is a cross-sectional view of a wire or winding in accordance with another embodiment of the present disclosure;

FIG. 4 is a cross-sectional view of a wire or winding in accordance with yet another embodiment of the present disclosure; and

FIG. 5 is a cross-sectional view of a wire or winding in accordance with yet another embodiment of the present disclosure still.

### DETAILED DESCRIPTION OF ILLUSTRATIVE EMBODIMENTS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

In the drawings, some structural or method features, such as those representing devices, modules, instructions blocks and data elements, may be shown in specific arrangements and/or orderings for ease of description. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

In some embodiments, schematic elements used to represent blocks of a method may be manually performed by a user. In other embodiments, implementation of those schematic elements may be automated using any suitable form of machine-readable instruction, such as software or firmware applications, programs, functions, modules, routines, processes, procedures, plug-ins, applets, widgets, code fragments and/or others, for example, and each such instruction may be implemented using any suitable programming language, library, application programming interface (API), and/or other software development tools. For instance, in some embodiments, the schematic elements may be implemented using Java, C++, and/or other programming languages. Similarly, schematic elements used to represent data or information may be implemented using any suitable electronic arrangement or structure, such as a register, data store, table, record, array, index, hash, map, tree, list, graph, file (of any file type), folder, directory, database, and/or others, for example.

Further, in the drawings, where connecting elements, such as solid or dashed lines or arrows, are used to illustrate a connection, relationship, or association between or among two or more other schematic elements, the absence of any such connection elements is not meant to imply that no connection, relationship, or association can exist. In other words, some connections, relationships, or associations between elements may not be shown in the drawings so as not to obscure the disclosure. In addition, for ease of illustration, a single connecting element may be used to represent multiple connections, relationships, or associations between elements. For example, where a connecting element represents a communication of signals, data or instructions, it should be understood by those skilled in the art that such element may represent one or multiple signal paths (e.g., a bus), as may be needed, to effect the communication.

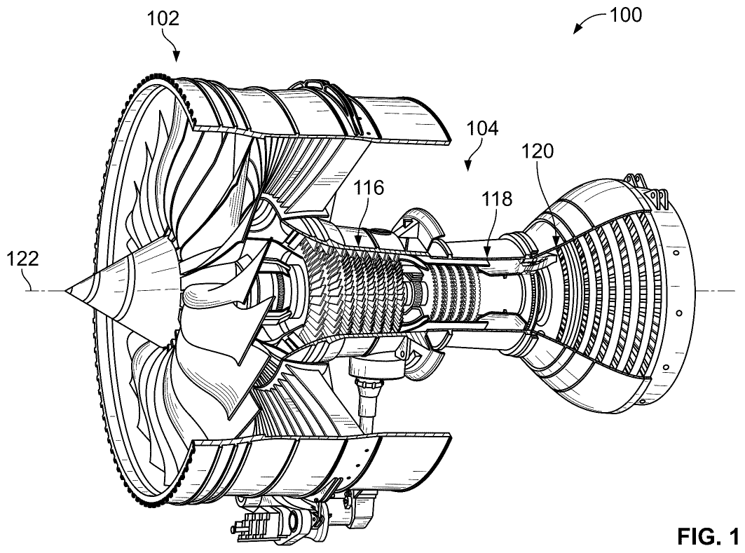

Referring now to FIG. 1, an illustrative aerospace gas turbine engine 100 includes a fan 102 and an engine core 104 adapted to drive the fan 102. In concert, the fan 102 and the engine core 104 are configured to push air and/or generate propulsive thrust to propel an aircraft. In the illustrative embodiment, the gas turbine engine 100 is a turbofan engine. In other embodiments, however, it should be appreciated that the gas turbine engine 100 may be another suitable engine, such as a turbojet engine, a turboprop engine, or a turboshaft engine, for example.

The gas turbine engine 100 illustratively includes a compressor 116, a combustor 118, and a turbine 120. The compressor 116 compresses air and delivers compressed air to the combustor 118. The combustor 118 mixes the compressed air with fuel, ignites the air/fuel mixture, and delivers the combustion products (i.e., hot, high-pressure gasses) to the turbine 120. The turbine 120 converts the combustion products to mechanical energy (i.e., rotational power) that drives the compressor 116 and the fan 102. The fan 102, the compressor 116, the combustor 118, and the turbine 120 are illustratively arranged along a central axis 122 of the gas turbine engine 100.

In some cases, high-temperature operating environments in the turbine 120 of the illustrative engine 100 may reach or exceed 450° F. In other cases, high-temperature operating environments in the turbine 120 may be in a range of 450° F. to 800° F. In other cases still, high-temperature operating environments in the turbine 120 may be in a range of 450° F. to 1000° F. In any case, the high operating temperature in the turbine 120 and/or the combustor 118 constrains the survivability of wires and/or windings disposed in the turbine 120 and/or the combustor 118.

In some embodiments, a variety of electrical and/or electro-magnetic devices (not shown) may be arranged in the turbine 120 and/or the combustor 118 such that electrical wires (e.g., the wires 200, 300), electrical windings, and/or electrical coils associated with those devices are subjected to the aforementioned high-temperature conditions. Those devices may include, but are not limited to, the following: one or more linear variable differential transformer (LVDT) position sensors; one or more rotary variable differential transformer (RVDT) position sensors; one or more synchro/resolver position sensors; one or more magnetic pickup speed sensors; one or more single-coil or dual-coil solenoids; one or more brushed or brushless DC motors; one or more AC motors; one or more stepper motors; one or more servomotors; one or more electrically-operated valves to control airflow; one or more electrically-operated valves to control fuel flow and/or air/fuel mixture; one or more electro-hydraulic servo valves; one or more electrically-operated actuators; one or more electrically-operated speed or load controls; and one or more electronic fuel injection systems. Additionally, in some embodiments, the devices and the associated wiring are specifically adapted for low voltage, electromagnetic-activated aerospace services, such as applications in which one or more multi-turn electrical coils is configured to deliver 10-15 volts of electrical power, for example.

In other embodiments, certain electrical and/or electro-magnetic devices (not shown) may be arranged in engines (e.g., turbine engines) used in other applications, such as industrial, construction, agricultural, marine, locomotive, and power generation applications, for instance. In those embodiments, electrical wires (e.g., the wires 200, 300), electrical windings, and/or electrical coils associated with those devices may be subjected high-temperature conditions, such as those discussed above. Those devices may include, but are not limited to, the following: one or more current-to-pressure (CPC) converters; one or more electrically-operated engine linear actuators; one or more electrically-operated engine integral actuators; one or more single-coil or dual-coil solenoids; one or more electrically-operated or electro-hydraulic proportional actuators; one or more linear electro-hydraulic actuators; one or more electronic fuel injection systems; one or more electro-pneumatic servo valves; and one or more electro-hydraulic servo valves.

Regardless of the particular device(s), the present disclosure envisions wires (e.g., the wires 200, 300, 400, 500) and/or winding materials to facilitate reduced mechanical stresses experienced at wire termination interfaces and/or joints, among other locations. Additionally, the present disclosure evaluates the mechanical constructions of, and the materials selected for, wires and/or winding materials subject to long-term thermal degradation. As discussed in greater detail below, each of the wires and/or winding materials contemplated by the present disclosure includes a conductor or conductor material(s) and an clad conductor or clad conductor material(s). Among other advantages, the wires and/or winding materials of the present disclosure offer suitable current-carrying capacity and dielectric properties allowing the particular device(s) to operate in a high-temperature environment without size or weight drawbacks.

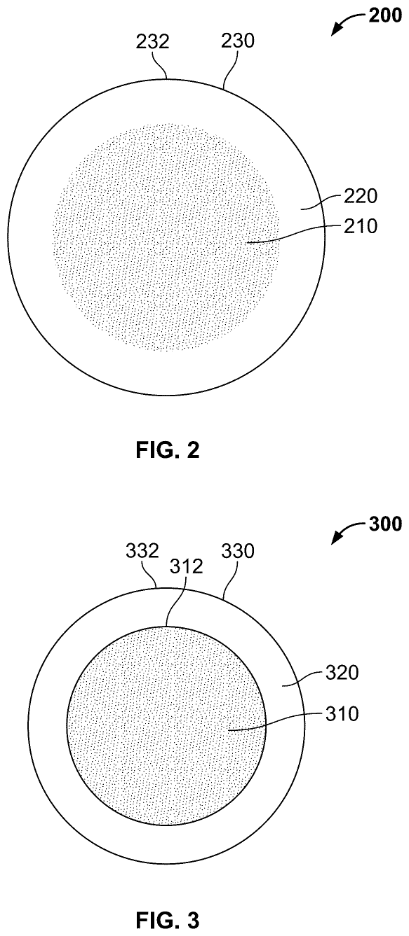

Referring now to FIG. 2, the illustrative wire 200 includes a metallic core material or metallic core layer 210 defining a cylindrical core or center of the wire 200. In the illustrative embodiment, the core material 210 is embodied as a core conductor material. In one example, the core conductor material includes copper. In another example, the core conductor material includes silver. In yet another example, the core conductor material includes gold. Regardless, in the illustrative embodiment, the core conductor material has a first resistance or resistivity.

In some embodiments, the core conductor material accounts for at least 60% of an entire cross-sectional area of the wire 200. In one example, the core conductor material accounts for between 60-90% of the entire cross-sectional area of the wire 200. In another example, the core conductor material accounts for about 80% of the entire cross-sectional area of the wire 200.

The illustrative wire 200 includes a metallic clad material or metallic clad layer 220 wound around the core material 210 such that the clad material 220 defines a cylindrical shape. In the illustrative embodiment, the clad material 220 is embodied as an clad conductor material. More specifically, the clad conductor material is configured to form an oxidation barrier to at least partially shield the core conductor material from oxidation in an oxygen-containing, high-temperature environment. In one example, the clad conductor material includes aluminum. In another example, the clad conductor material includes 1000 series aluminum, such as 1350 series aluminum, for instance. In yet another example still, the clad conductor material includes 2000 series aluminum. Further, in another example, the clad conductor material includes 6000 series aluminum. Regardless, in the illustrative embodiment, the clad conductor material has a second resistance or resistivity greater than the first resistance or resistivity.

In some embodiments, the clad conductor material accounts for about 40% of the entire cross-sectional area of the wire 200. In one example, the clad conductor material accounts for between 10-40% of the entire cross-sectional area of the wire 200. In another example, the clad conductor material accounts for about 20% of the entire cross-sectional area of the wire 200.

The illustrative wire 200 includes an anodized skin 230 formed on, and from, the clad conductor material 220. In the illustrative embodiment, the anodized skin 230 defines a radially outermost exterior finish 232 of the wire 200. The illustrative finish 232 is an anodic/aluminum oxide finish configured to at least partially electrically insulate the clad conductor material 220 in use of the wire 200. Furthermore, the illustrative finish 232 provides some degree of protection against short circuits resulting from wire-to-wire contact. Additionally, in some embodiments, the finish 232 may be at least partially corrosion-resistant.

In the illustrative embodiment, the anodized skin 230 has a thickness of about 1 μm and accounts for a minute percentage (e.g., between 0-1%) of the entire cross-sectional area of the wire 200. The illustrative skin 230 is formed by a chromic acid or type 1 anodizing process. In other embodiments, however, the skin 230 may be formed by another anodizing process, such as a normal/clear sulfuric acid anodizing process or a hardcoat sulfuric acid anodizing process, for example.

In some embodiments, the overall conductor/clad conductor package including the core conductor material 210, the clad conductor material 220, and the anodized skin 230 improves the current-carrying capacity of the wire 200 and/or increases the current density (e.g., measured in amps/turn) of electromagnetic coils formed from the wire 200. Those advantages facilitate reduction in the size and weight of the wires and coils in a manner particularly advantage to aerospace applications, at least in some embodiments. Of course, it should be appreciated that size and weight reductions achieved through use of the wire 200 may be beneficial in other applications.

Referring now to FIG. 3, the illustrative wire 300 includes a metallic core material or metallic core layer 310 defining a cylindrical core or center of the wire 300. In the illustrative embodiment, the core material 310 is embodied as a core conductor material. In one example, the core conductor material includes copper. In another example, the core conductor material includes silver. In yet another example, the core conductor material includes gold. Regardless, in the illustrative embodiment, the core conductor material has a first resistance or resistivity.

In some embodiments, the core conductor material accounts for at least 60% of an entire cross-sectional area of the wire 300. In one example, the core conductor material accounts for between 60-90% of the entire cross-sectional area of the wire 300. In another example, the core conductor material accounts for about 80% of the entire cross-sectional area of the wire 300.

The illustrative wire 300 includes a metallic interlayer 312 wound around the core conductor material 310 and arranged between the core conductor material 310 and clad conductor material 320. In the illustrative embodiment, the interlayer 312 is positioned between the materials 310, 320 to at least partially inhibit deleterious intermetallic formation between the core conductor material 310 and the clad conductor material 320. In some embodiments, the interlayer 312 may restrict intermetallic diffusion between the materials 310, 320. Additionally, in some embodiments, the interlayer 312 may at least partially strengthen and/or reinforce the metallic microstructure of the core conductor material 310 and/or the clad conductor material 320.

In some embodiments, the interlayer 312 has a small thickness and accounts for a small percentage (e.g., between 0-5%) of the entire cross-sectional area of the wire 300. In embodiments where the core conductor material 310 includes copper and the clad conductor material 320 includes aluminum, the interlayer 312 may include a mixture of copper and aluminum. In such embodiments, copper and aluminum particles may be mixed in the interlayer 312 to achieve a desired degree of homogeneity, or lack thereof. Additionally, in some embodiments, the copper material may account for at least 5% of the interlayer 312, and the aluminum material may account for at least 90% of the interlayer 312. For instance, the copper material may account for about 6% of the interlayer 312, and the aluminum material may account for about 94% of the interlayer 312.

In embodiments where the core conductor material 310 includes silver and the clad conductor material 320 includes aluminum, the interlayer 312 may include a mixture of silver and aluminum. In such embodiments, silver and aluminum particles may be mixed in the interlayer 312 to achieve a desired degree of homogeneity, or lack thereof.

In embodiments where the core conductor material 310 includes gold and the clad conductor material 320 includes aluminum, the interlayer 312 may include a mixture of gold and aluminum. In such embodiments, gold and aluminum particles may be mixed in the interlayer 312 to achieve a desired degree of homogeneity, or lack thereof.

The illustrative wire 300 includes the metallic clad material or metallic clad layer 320 wound around the interlayer 312 such that the clad conductor material 320 defines a cylindrical shape. In the illustrative embodiment, the clad material 320 is embodied as an clad conductor material. More specifically, the clad conductor material is configured to form an oxidation barrier to at least partially shield the core conductor material from oxidation in an oxygen-containing, high-temperature environment. In one example, the clad conductor material includes aluminum. In another example, the clad conductor material includes 1000 series aluminum, such as 1350 series aluminum, for instance. In yet another example, the clad conductor material includes 2000 series aluminum. In yet another example still, the clad conductor material includes 6000 series aluminum. Regardless, in the illustrative embodiment, the clad conductor material has a second resistance or resistivity greater than the first resistance or resistivity.

In some embodiments, the clad conductor material accounts for 35-40% of the entire cross-sectional area of the wire 300. In one example, the clad conductor material accounts for between 10-40% of the entire cross-sectional area of the wire 300. In another example, the clad conductor material accounts for about 20% of the entire cross-sectional area of the wire 300.

The illustrative wire 300 includes an anodized skin 330 formed on, and from, the clad conductor material 320. In the illustrative embodiment, the anodized skin 330 defines a radially outermost exterior finish 332 of the wire 200. The illustrative finish 332 is an anodic/aluminum oxide finish configured to electrically insulate the clad conductor material 320 in use of the wire 300. Furthermore, the illustrative finish 332 provides some degree of protection against short circuits resulting from wire-to-wire contact. Additionally, in some embodiments, the finish 332 may be at least partially corrosion-resistant.

In the illustrative embodiment, the anodized skin 330 has a thickness of about 1 μm and accounts for a minute percentage (e.g., between 0-1%) of the entire cross-sectional area of the wire 300. The illustrative skin 330 is formed by a chromic acid or type 1 anodizing process. In other embodiments, however, the skin 330 may be formed by another anodizing process, such as a “normal/clear” sulfuric acid anodizing process or a “hardcoat” sulfuric acid anodizing process, for example.

In some embodiments, the overall conductor/clad conductor package including the core conductor material 310, the interlayer 312, the clad conductor material 320, and the anodized skin 330 improves the current-carrying capacity of the wire 300 and/or increases the current density (e.g., measured in amps/turn) of electromagnetic coils formed from the wire 300. Those advantages facilitate reduction in the size and weight of the wires and coils in a manner particularly advantage to aerospace applications, at least in some embodiments. Of course, it should be appreciated that size and weight reductions achieved through use of the wire 300 may be beneficial in other applications.

The present disclosure contemplates a unique conductor/clad conductor system (e.g., the wires 200, 300, 600, 700) having advantageous properties enabling use thereof in high-temperature environments, such as gas turbine engines for aerospace vehicles, in particular. Those properties include, but are not limited to, the following: high and/or increased ratio of conductor current density to mass/volume density of the wire/coil; high and/or increased conductivity; low and/or decreased temperature coefficient of resistivity; high and/or increased insulation dielectric capability; low and/or decreased manufacturing cost; high and/or increased compatibility with existing electromagnetic coil manufacturing techniques. The use of a copper conductor (e.g., the core conductor material 210, 310) effects high or increased current density at low resistivity of the bulk of the conductor. The clad conductor material (e.g., the clad material 220, 320) of aluminum facilitates high or increased conductivity of the system while forming an oxidation barrier that protects the core copper conductor from continuous oxidation at high temperature in oxygen-containing environments.

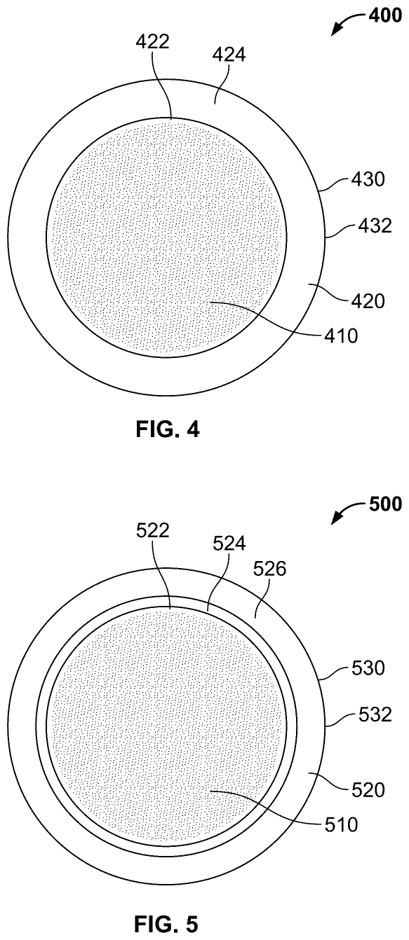

Referring now to FIG. 4, the illustrative wire 400 includes a metallic core material or metallic core layer 410 defining a cylindrical core or center of the wire 400. In the illustrative embodiment, the core material 410 is embodied as a conductor material. In one example, the conductor material includes copper. In another example, the conductor material includes silver. In yet another example, the conductor material includes gold. Regardless, in the illustrative embodiment, the conductor material has a first resistance or resistivity.

In some embodiments, the conductor material accounts for at least 60% of an entire cross-sectional area of the wire 400. In one example, the conductor material accounts for between 60-90% of the entire cross-sectional area of the wire 400. In another example, the conductor material accounts for about 80% of the entire cross-sectional area of the wire 400.

The illustrative wire 400 includes a metallic clad material or metallic clad layer 420 wound around the core material 410 such that the clad material 420 defines a cylindrical shape. In the illustrative embodiment, the clad material 420 is embodied as a clad conductor material. More specifically, the clad conductor material is configured to form an oxidation barrier to at least partially shield the core conductor material from oxidation in an oxygen-containing, high-temperature environment. In one example, the clad conductor material includes aluminum. In another example, the clad conductor material includes 1000 series aluminum, such as 1350 series aluminum, for instance. In yet another example, the clad conductor material includes 2000 series aluminum. In yet another example still, the clad conductor material includes 6000 series aluminum. Regardless, in the illustrative embodiment, the clad conductor material has a second resistance or resistivity greater than the first resistance or resistivity.

In some embodiments, the clad conductor material accounts for about 40% of the entire cross-sectional area of the wire 400. In one example, the clad conductor material accounts for between 10-40% of the entire cross-sectional area of the wire 400. In another example, the clad conductor material accounts for about 20% of the entire cross-sectional area of the wire 400.

In the illustrative embodiment, the clad layer 420 has a di-layer construction to at least partially lessen or inhibit intermetallic diffusion or formation between the conductor material of the core layer 410 and the clad conductor material of the clad layer 420. As such, the clad layer 420 includes an inner layer 422 and an outer layer 424. In the illustrative embodiment, the inner layer 422 is formed from copper material and the outer layer 424 is formed from 2000 series aluminum material. In some embodiments, the inner layer 422 may account for about 6% of the clad layer 420, and the outer layer 424 may account for about 94% of the clad layer 420. The copper inner layer 422 and the aluminum outer layer 424 may cooperate to establish a chemical interdiffusion gradient in which the chemical reactivity of the clad layer 420 increases in the radially outward direction. That gradient may reduce intermetallic diffusion or formation between the conductor material of the core layer 410 and the clad conductor material of the clad layer 420 in use of the wire 400.

The illustrative wire 400 includes an anodized skin 430 formed on, and from, the clad material 420. In the illustrative embodiment, the anodized skin 430 defines a radially outermost exterior finish 432 of the wire 400. The illustrative finish 432 is an anodic/aluminum oxide finish configured to electrically insulate the clad material 420 in use of the wire 400. Furthermore, the illustrative finish 432 provides some degree of protection against short circuits resulting from wire-to-wire contact. Additionally, in some embodiments, the finish 432 may be at least partially corrosion-resistant.

In the illustrative embodiment, the anodized skin 430 has a thickness of about 1 μm and accounts for a minute percentage (e.g., between 0-1%) of the entire cross-sectional area of the wire 400. The illustrative skin 430 is formed by a chromic acid or type 1 anodizing process. In other embodiments, however, the skin 430 may be formed by another anodizing process, such as a normal/clear sulfuric acid anodizing process or a hardcoat sulfuric acid anodizing process, for example.

In some embodiments, the overall conductor/clad conductor package including the core material 410, the clad material 420, and the anodized skin 430 improves the current-carrying capacity of the wire 400 and/or increases the current density (e.g., measured in amps/turn) of electromagnetic coils formed from the wire 400. Those advantages facilitate reduction in the size and weight of the wires and coils in a manner particularly advantage to aerospace applications, at least in some embodiments. Of course, it should be appreciated that size and weight reductions achieved through use of the wire 400 may be beneficial in other applications.

Referring now to FIG. 5, the illustrative wire 500 includes a metallic core material or metallic core layer 510 defining a cylindrical core or center of the wire 500. In the illustrative embodiment, the core material 510 is embodied as a conductor material. In one example, the conductor material includes copper. In another example, the conductor material includes silver. In yet another example, the conductor material includes gold. Regardless, in the illustrative embodiment, the conductor material has a first resistance or resistivity.

In some embodiments, the conductor material accounts for at least 60% of an entire cross-sectional area of the wire 500. In one example, the conductor material accounts for between 60-90% of the entire cross-sectional area of the wire 500. In another example, the conductor material accounts for about 80% of the entire cross-sectional area of the wire 500.

The illustrative wire 500 includes a metallic clad material or metallic clad layer 520 wound around the core material 510 such that the clad material 520 defines a cylindrical shape. In the illustrative embodiment, the clad material 520 is embodied as a clad conductor material. More specifically, the clad conductor material is configured to form an oxidation barrier to at least partially shield the conductor material from oxidation in an oxygen-containing, high-temperature environment. In one example, the clad conductor material includes aluminum. In another example, the clad conductor material includes 1000 series aluminum, such as 1350 series aluminum, for instance. In yet another example, the clad conductor material includes 2000 series aluminum. In yet another example still, the clad conductor material includes 6000 series aluminum. Regardless, in the illustrative embodiment, the clad conductor material has a second resistance or resistivity greater than the first resistance or resistivity.

In some embodiments, the clad conductor material accounts for about 40% of the entire cross-sectional area of the wire 500. In one example, the clad conductor material accounts for between 10-40% of the entire cross-sectional area of the wire 500. In another example, the clad conductor material accounts for about 20% of the entire cross-sectional area of the wire 500.

In the illustrative embodiment, the clad layer 520 has a tri-layer construction to at least partially lessen or inhibit intermetallic diffusion or formation between the conductor material of the core layer 510 and the clad conductor material of the clad layer 520. As such, the clad layer 520 includes an inner layer 522, an intermediate layer 524, and an outer layer 526. In the illustrative embodiment, the inner layer 522 is formed from copper material, the intermediate layer 524 is formed from nickel material, and the outer layer 526 is formed from 2000 series aluminum material. The copper inner layer 522, the nickel intermediate layer 524, and the aluminum outer layer 526 may cooperate to establish a chemical interdiffusion gradient in which the chemical reactivity of the clad layer 520 increases in the radially outward direction. That gradient may reduce intermetallic diffusion or formation between the conductor material of the core layer 510 and the clad conductor material of the clad layer 520 in use of the wire 500.

The illustrative wire 500 includes an anodized skin 530 formed on, and from, the clad material 520. In the illustrative embodiment, the anodized skin 530 defines a radially outermost exterior finish 532 of the wire 500. The illustrative finish 532 is an anodic/aluminum oxide finish configured to electrically insulate the clad material 520 in use of the wire 500. Furthermore, the illustrative finish 532 provides some degree of protection against short circuits resulting from wire-to-wire contact. Additionally, in some embodiments, the finish 532 may be at least partially corrosion-resistant.

In the illustrative embodiment, the anodized skin 530 has a thickness of about 1 μm and accounts for a minute percentage (e.g., between 0-1%) of the entire cross-sectional area of the wire 500. The illustrative skin 530 is formed by a chromic acid or type 1 anodizing process. In other embodiments, however, the skin 530 may be formed by another anodizing process, such as a normal/clear sulfuric acid anodizing process or a hardcoat sulfuric acid anodizing process, for example.

In some embodiments, the overall conductor/clad conductor package including the core material 510, the clad material 520, and the anodized skin 530 improves the current-carrying capacity of the wire 500 and/or increases the current density (e.g., measured in amps/turn) of electromagnetic coils formed from the wire 500. Those advantages facilitate reduction in the size and weight of the wires and coils in a manner particularly advantage to aerospace applications, at least in some embodiments. Of course, it should be appreciated that size and weight reductions achieved through use of the wire 500 may be beneficial in other applications.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

What is claimed is:

1. A wire comprising:
a metallic core conductor material having a first resistance;
a metallic clad conductor material having a second resistance greater than the first resistance; and
a metallic interlayer arranged between the core conductor material and the clad conductor material to at least partially inhibit deleterious intermetallic formation between the clad conductor material and the core conductor material.

2. The wire of claim 1, wherein:
the clad conductor material includes aluminum;
the core conductor material includes copper; and
the interlayer includes copper and aluminum.

3. The wire of claim 2, further comprising an anodized skin formed on the aluminum clad conductor material.

4. The wire of claim 3, wherein the clad conductor material includes 1000 series aluminum.

5. The wire of claim 3, wherein the clad conductor material includes 2000 series aluminum.

6. The wire of claim 3, wherein the clad conductor material includes 6000 series aluminum.

7. The wire of claim 5, wherein the aluminum material accounts for at least 90% of the interlayer.

8. The wire of claim 7, wherein the copper material accounts for at least 5% of the interlayer.

9. The wire of claim 1, wherein:
the clad conductor material includes aluminum;
the core conductor material includes copper; and
the interlayer includes copper, nickel, and aluminum.

10. The wire of claim 9, wherein:
the copper material at least partially forms a radially innermost layer of the interlayer;
the aluminum material at least partially forms a radially outermost layer of the interlayer; and
the nickel material at least partially forms an intermediate layer between the radially innermost layer and the radially outermost layer.

11. A wire comprising:
a metallic core conductor material having a first resistance;
a metallic clad conductor material having a second resistance greater than the first resistance; and
an anodized skin formed on the clad conductor material.

12. The wire of claim 11, wherein:
the core conductor material includes copper; and
the clad conductor material includes aluminum.

13. The wire of claim 11, wherein:
the core conductor material includes silver; and
the clad conductor material includes aluminum.

14. The wire of claim 11, wherein:
the core conductor material includes gold; and
the clad conductor material includes aluminum.

15. The wire of claim 11, wherein:
the core conductor material includes copper; and
the clad conductor material includes copper and aluminum.

16. The wire of claim 15, wherein:
the anodized skin is formed on the aluminum clad conductor material;
the copper material at least partially forms a radially innermost layer of the clad conductor material; and
the aluminum material at least partially forms a radially outermost layer of the clad conductor material.

17. The wire of claim 15, wherein:
the clad conductor material includes nickel;
the copper material at least partially forms a radially innermost layer of the clad conductor material;
the aluminum material at least partially forms a radially outermost layer of the clad conductor material; and
the nickel material at least partially forms an intermediate layer between the radially innermost layer and the radially outermost layer.

18. A wire comprising:
a metallic core conductor material having a first resistance; and
a metallic clad conductor material having a second resistance greater than the first resistance;
wherein:
the core conductor material includes copper;
the clad conductor material includes copper and aluminum;
the copper material at least partially forms a first layer of the clad conductor material; and
the aluminum material at least partially forms a second layer of the clad conductor material arranged radially outward of the first layer.

19. The wire of claim 18, wherein:
the clad conductor material includes nickel; and
the nickel material at least partially forms a third layer of the clad conductor material between the first layer and the second layer.

20. The wire of claim 19, wherein the first layer and the third layer of the clad conductor material at least partially inhibit deleterious intermetallic formation between the core conductor material and the second layer of the clad conductor material.
